(19) United States
(12) Patent Application Publication
(10) Pub. No.: US 2026/0112089 A1
(43) Pub. Date: Apr. 23, 2026

(54) SYSTEM AND METHOD FOR SYNCHRONIZED STORYTELLING

(71) Applicant: Bubble Books, Inc., Weston, FL (US)

(72) Inventor: Robert Alon, Weston, FL (US)

(21) Appl. No.: 19/362,290

(22) Filed: Oct. 17, 2025

Related U.S. Application Data
(60) Provisional application No. 63/709,304, filed on Oct. 18, 2024.

(51) Int. Cl. G06T 11/60; G06F 16/903; G06V 30/10; G10L 15/26

(52) U.S. Cl. CPC G06T 11/60; G06F 16/90344; G06V 30/10; G10L 15/26

(57) ABSTRACT

The system and method for synchronized storytelling on a computer-implemented platform, comprising an input module for obtaining narration data, a database for storing at least one book file, wherein the book file comprises a plurality of book pages, each of the plurality of book pages comprises text instances, a processing module configured to optically recognize the text instances, and a display module for displaying the narration data at an output pace and generating a highlight overlay on the text instances according to the output pace.

### CROSS REFERENCE TO RELATED APPLICATION

This application claims the benefit of priority under 35 U.S.C. §120 of U.S. Provisional Application No. 63/709,304, filed Oct. 18, 2024, entitled DIGITAL STORYTELLING PLATFORM, which is hereby incorporated by reference as if set forth herein in its entirety.

### BACKGROUND

Traditional storytelling methods, such as audio books and read-aloud books, lack visual engagement or a personal touch. These methods do not fully leverage modern technology to create an immersive and interactive reading experience. Digital storybooks conventionally rely on pre-recorded narration with manually mapped text highlights, which may not be changed depending on narrator's pacing or cadence. As such, digital storybooks often are often only presets, and not customizable based on user preference. The computer-implemented synchronized storytelling platform aims to address these gaps by providing a system where children can see and hear their loved ones or favorite characters narrate stories, thus fostering a love for reading and strengthening emotional bonds.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, a computer-implemented synchronized storytelling platform comprises a recording module configured to obtain narration input data, a database configured to store at least one book file, wherein the book file comprises a plurality of book pages, each of the plurality of book pages comprises text instances, a synchronization module configured to assign timestamps to the narration input data and map the timestamps to the text instances, and a display module. The display module generates a display of the book file, displaying each of the plurality of book pages. The display module generates an output overlay over a display of the book file, wherein the output overplay comprises an output display of the narration input data at an output cadence based on the timestamps. The display module generates a highlight overlay over the text instances according to the output cadence.

In various implementations, a computer-implemented method for synchronized storytelling platform comprises obtaining narration input data from a recording module; loading at least one book file from a database, wherein the book file comprises a plurality of book pages, each of the plurality of book pages comprises text instances; assigning timestamps to the narration input data; mapping the timestamps to the text instances; displaying the book file on a display module; recognizing, optically, the text instances of the book file; generating an output overlay of the narration input data over the book file, and generating a highlight overlay over each of the text instances according to an output cadence based on the timestamps.

In various implementations, a computer-implemented synchronized storytelling platform comprises an input module for obtaining narration data, a database for storing at least one book file, wherein the book file comprises a plurality of book pages, each of the plurality of book pages comprises text instances, a processing module configured to optically recognize the text instances, and a display module for displaying the narration data at an output pace and generating a highlight overlay on the text instances according to the output pace.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a block diagram of an example of a computer-implemented synchronized storytelling platform in accordance with subject disclosure.

FIG. 2 is a block diagram of an example of an architecture of the computer-implemented synchronized storytelling platform in accordance with the subject disclosure.

FIG. 3 is a block diagram of real-time speech-to-text process utilizing the computer-implemented synchronized storytelling platform in accordance with the subject disclosure.

FIG. 4 is a block diagram of the computer-implemented synchronized storytelling platform in accordance with the subject disclosure.

FIG. 5a-b is a process diagram of book browsing utilizing the computer-implemented synchronized storytelling platform in accordance with the subject disclosure.

FIG. 6a-c is a process diagram of narrator browsing utilizing the computer-implemented synchronized storytelling platform in accordance with the subject disclosure.

FIG. 7a-c is a process diagram of a sign in process utilizing the computer-implemented synchronized storytelling platform in accordance with the subject disclosure.

FIG. 8a-f are process diagrams of a narration recording process utilizing the computer-implemented synchronized storytelling platform in accordance with the subject disclosure.

FIG. 9a-b is a process diagram of a parent user browsing process utilizing the computer-implemented synchronized storytelling platform in accordance with the subject disclosure.

FIG. 10a-d is a process diagram of a child user browsing process utilizing the computer-implemented synchronized storytelling platform in accordance with the subject disclosure.

FIG. 11a-b are examples of narration recording displays utilizing the computer-implemented synchronized storytelling platform in accordance with the subject disclosure.

FIG. 12 is an example of a digital page displaying the narration utilizing the computer-implemented synchronized storytelling platform in accordance with the subject disclosure.

FIG. 13 is an example of a digital page of narration recording utilizing the computer-implemented synchronized storytelling platform in accordance with subject disclosure.

FIG. 14 is an example of a digital page of narration recording utilizing the computer-implemented synchronized storytelling platform in accordance with subject disclosure.

FIG. 15 is an example of a digital page playing back a recorded narration utilizing the computer-implemented synchronized storytelling platform in accordance with subject disclosure.

FIG. 16 is an example of a digital plage playing back a recorded narration utilizing the computer-implemented synchronized storytelling platform in accordance with subject disclosure.

### DETAILED DESCRIPTION

The present invention is a computer-implemented synchronized storytelling platform that is designed to provide customizable narration with visual components to readers. The computer-implemented synchronized storytelling platform enables a user to record narration of books synced to a reading pace that is appropriate to a designated reader, along with accompany visual representation of the narration. The visual representation is provided in the form of video recording of the narrator, video avatar representation of the narrator, or an existing character. The digital platform synchronizes narration by the user along with visual recording, wherein the narration is played back to the reader through a display window on each page of the book on the computer-implemented synchronized storytelling platform. The combined output of the audio and visual recording played back at a pace that is personalized to the intended user provides a complete and unique experience to the user.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to a “module”, “a software module”, and the like, indicate a software component or part of a program, an application, and/or an app that contains one or more routines. One or more independently modules can comprise a program, an application, and/or an app.

References to an “app”, an “application”, and a “software application” shall refer to a computer program or group of programs designed for end users. The terms shall encompass standalone applications, thin client applications, thick client applications, web-based applications, such as a browser, and other similar applications.

“Artificial Intelligence (AI)” is not limited by the method, source, and location of its implementation. AI is intended to be a system or process configured to encompass any necessary elements to deliver intended results through an autonomized process. AI is presented as embodied via multi-stage or server-based processing, but it is not limited to such implementation in the vision of the present invention. It could be either, both, or formed from the operation of several systems despite that we only control/configure a few of them but where our invention makes the complete mechanism to form the method and utility we describe.

Numerous specific details are set forth in order to provide a thorough understanding of one or more embodiments of the described subject matter. It is to be appreciated, however, that such embodiments can be practiced without these specific details.

The computer-implemented synchronized storytelling platform combines traditional book reading with interactive video narration technology. The system enable users to create an augmented digital story book (named a “bubble book” in an example, for speech bubbles that appear in story books) that is enhanced with synchronized video narrations. The video narrations may appear as floating video bubbles overlaid on book pages, with real-time speech and teleprompter functionality.

In various implementations, the computer-implemented synchronized storytelling platform may provide a dynamic draggable video overlay that maintains aspect ratio and positioning across different screen orientations and device types. The draggable video overlay may be implemented as a circular video frame over a story book screen. In an example, the circular video frame may be 100 pixels on phones and 200 pixels on tablets. The size and dimensions of the circular video frame may be adapted to specific user requirements. The video overlay may enable adaptive sizing, wherein responsive bubble size may be enabled based on device type and orientation.

In an example, the video overlay may enable gesture-based positioning. This may be enabled by pan gesture detection with decay animation and boundary clamping. The overlay positioning may be managed at z-index 100 to float above digital text content. The overlay may be implemented as cross-platform compatible and support consistent behavior across iOS and android.

The computer-implemented synchronized storytelling platform may provide real-time speech-to-text highlighting, providing synchronized word-level highlighting that combines optical character recognition (TEXT EXTRACTION with speech transcript timestamps using fuzzy string matching. The TEXT EXTRACTION integration may be implemented through a React Native ML Kit for real=time text recognition from digital text snapshots, in an example.

The computer-implemented synchronized storytelling platform may comprise timestamp synchronization, wherein 50 ms precision playback monitoring may be enabled with word-level transcript matching. The computer-implemented synchronized storytelling platform may enable fuzzy text alignment, wherein Levenshtein distance algorithm may be enabled for matching TEXT EXTRACTION results with speech transcripts. Real-time calculation of highlight box coordinates may be enabled based on TEXT EXTRACTION element frames, such that the storytelling platform provides dynamic highlight positioning. In an example, the visual highlighting may comprise semi-transparent blue overlay with rounded corners, wherein 40% opacity may be configured.

The computer-implemented synchronized storytelling platform may comprise an intelligent teleprompter system, wherein context-aware text display may display page-specific content during recording with automatic scrolling and formatting. The intelligent teleprompter system may comprise page-specific content support, enabling dynamic loading of book page transcripts from a database. A responsive layout may be provided, wherein optimal user experience may be supported on both mobile devices and tablets.

In various examples, the intelligent teleprompter may comprise a high contrast display, wherein black background with white text may be configured for optimal readability. Large fonts may be utilized for easy reading during recording, and automatic text wrapping with preserved line breaks may be utilized for line-by-line formatting. The display may be adapted based on user preference and device selection.

The computer-implemented synchronized storytelling platform may comprise a proprietary Text-to-speech alignment algorithm. The alignment algorithm may comprise text extraction from digital text page snapshots, wherein the digital text may be supplied either as proprietary documents or third-party supplied documents. The Text-to-speech alignment may be supported by fuzzy string matching using Levenshtein distance, but any appropriate string metric may be adapted by a person with ordinary skills in the art to enable fuzzy string matching based on the specific description herein.

The computer-implemented synchronized storytelling platform may comprise temporal synchronization, wherein speech transcript timestamps may be provided. The Text-to-speech alignment may support a degree of error tolerance, wherein TEXT EXTRACTION inaccuracies and speech variations may be addressed by the proprietary algorithm.

The computer-implemented synchronized storytelling platform may comprise dynamic media synchronization, comprising multi-format support for both audio and video narrations. In an example, media synchronization may support precise timing control with 50 ms update intervals. The dynamic media synchronization may support cross-platform consistency across iOS and Android devices, and provide adaptive quality based on device capabilities and network conditions.

The computer-implemented synchronized storytelling platform may comprise intelligent content processing, which may support automated transcript generation for word-level timestamps, character-to-word timestamp conversion for voice cloning, background processing with queue management, and error handling and retry logic for robust media processing.

Overall, the computer-implemented synchronized storytelling platform differentiates from conventional voice-to-text or storybook applications through a plurality of technical implementations. The computer-implemented synchronized storytelling platform comprises a hybrid Text-to-speech synchronization, which combines real-time text extraction with speech recognition for precise text highlighting. The computer-implemented synchronized storytelling platform further comprises a context-aware teleprompter, providing intelligent text display systems that adapts to content and device characteristics. The computer-implemented synchronized storytelling platform further comprises multi-modal recording, providing seamless switching between audio and video recording modes with consistent user experience. Further, the computer-implemented synchronized storytelling platform comprises a real-time processing pipeline, enabling efficient background processing of media with immediate user feedback.

The computer-implemented synchronized storytelling platform comprises a hybrid Text-to-speech synchronization implementation, wherein visual text recognition and audio analysis are combined. The computer-implemented synchronized storytelling platform utilizes real-time digital text snapshot, wherein the current digital text page of a story book may be captured using a snapshot module at a certain time interval or upon page change. The text extraction processing may be enabled by a snapshot module and a text recognition module, such that text elements may be extracted with precise coordinate frames for each recognized word or phrase.

The computer-implemented synchronized storytelling platform comprises a proprietary speech transcript alignment, using a fuzzy matching algorithm to align the text extraction results with word-level timestamps. In various examples, the fuzzy matching algorithm may comprise Levenshtein distance.

In practice, the speech transcript alignment may comprise comparing first 3 words from text extraction with first 3 words from transcript, allowing up to 1 character difference from matching and according for text extraction errors, and mapping remaining text extraction elements to transcript timeline. The length of the characters for comparison may be adapted to accommodate specific user preference and requirements.

During playback, the computer-implemented synchronized storytelling platform may monitor audio and video position through predetermined time periods and highlight the corresponding text extraction element when its timestamp matches the current playback time.

Furthermore, the computer-implemented synchronized storytelling platform comprises multi-modal recording implementation, enabling seamless switching between audio and video recording modes. This may be achieved through dynamic permission management and unified recording interface.

The dynamic permission management allows the computer-implemented synchronized storytelling platform to request different permission sets (i.e., microphone only for audio vs. camera and microphone for video) and initializes the appropriate recording components based on user selection.

The unified recording interface may utilize a single recording control component that adapts its behavior depending on audio or video mode. For audio mode, the recording controls component may initialize recording with high quality presets. For video mode, the recording controls component may activate corresponding camera components and enable draggable video bubble overlay. A shared recording state system may track the current mode and manage transitions, ensuring consistent user experience regardless of the selected format. The computer-implemented synchronized storytelling platform comprises a backend processing utilizing speech-to-text transcription and enhancement pipeline, with format-specific handling at each stage.

The computer-implemented synchronized storytelling platform does not rely on pre-defined text positions. Instead, the platform dynamically discovers text locations through text extraction and synchronize their locations with speech I real-time. This enables the computer-implemented synchronized storytelling platform to work with any digital text content.

As used herein, a ‘book file’ may comprise any digital text format, including but not limited to digital text, EPUB, HTML, or proprietary formats, wherein the text content may be obtained either through optical recognition or through direct access to structured text data. The synchronized storytelling platform may dynamically extract, parse, and display text instances from such files for real-time highlighting synchronized to narration input.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

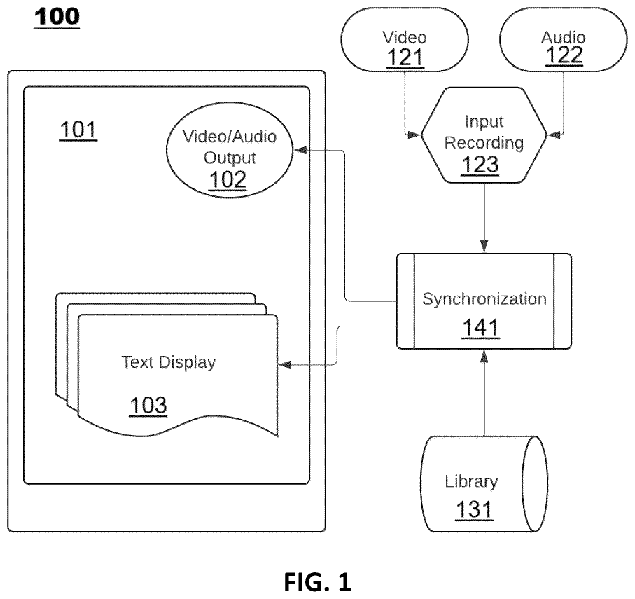

The present invention relates to a digital story telling platform. Referring to FIG. 1, the computer-implemented synchronized storytelling platform 100 provides the narration through a superimposed display 102 of a narrator on each digital book page 103 on a display device 101. The superimposed video display 102 may take the form of a window, bubble, or borderless area wherein the narrator is displayed. Opaque level of the superimposed video display 102 is customizable to allow a desirable ratio of text and video for the reader.

In various implementations, the computer-implemented synchronized storytelling platform 100 comprises editing tools for customization, adding multimedia effects to the recorded narration for extensive personalization. The multimedia effects comprise filters, effects, noise cancelation, and background templates. The computer-implemented synchronized storytelling platform 100 is configured to enable complete control on presentation of the recorded material by the user.

The computer-implemented synchronized storytelling platform 100 incorporates synchronization modules 141 to present the narration in a pace that is specific to the user. As each narrator should understand the needs and preferences of each user, the narration is recorded with such considerations in mind. Therefore, the narration is played along with each page 103 of a digital book at a pace that can be appreciated by the reader. It is envisioned that the computer-implemented synchronized storytelling platform 100 provides a bespoke reading experience to each reader in a way that replicates that of a real-life narrator.

In various implementations, the computer-implemented synchronized storytelling platform 100 is a system with a hardware and software component. The hardware component is implemented as a smart phone, tablet, computer, or smart TV in exemplary embodiments. The software component comprises a user interface for browsing books, recording narration, and customizing the reading experience. A database is provided through a combination of hardware and software implementations to enable storage of digital books, narration data (audio and visual), and user data.

The computer-implemented synchronized storytelling platform 100 enables users to browse a library of digital books within the database 131. Also stored within the database 131 is a collection of narration data, with both audio and visual components. The user is able to browse and select any of the digital books and narration combination through the user interface.

The narration data is generated at least through recording on the computer-implemented synchronized storytelling platform. In various embodiments, a user records their version of narration of a digital story through the personal computing device that houses the platform, including with built-cameras, teleprompters, and display (such as on a mobile phone).

The user can choose to record videos of themselves, use computer-generated clones, or utilize an animated avatar accompanying the narration. The recorded videos, clones, or avatars are synched through a proprietary algorithm to the pacing of the narration, wherein a seamless depiction of a personalized narrator is provided to the readers. For non-animated narrators, a built-in teleprompter is provided through the user interface, displaying the story's text on screen. Both the animated and non-animated narrators assist users in delivering smooth and accurate storytelling experience. Upon recording, the video narration is overlayed over each page of the digital book, wherein preview of the narration experience can be evaluated.

The computer-implemented synchronized storytelling platform comprises customization modules that allow users to add effects, filters, noise cancelling, and other multimedia elements to enhance the storytelling experience. A plurality of multimedia effects allows users to create bespoke narration videos that are synched with an appropriate reading pace that is specific to the user. Because the narration is created by users that, ideally, are knowledgeable to the user's preference, such narration recordings are presented as personalized visual dialogues that invoke companionship.

In various aspects, the computer-implemented synchronized storytelling platform 100 may comprise a system for content management. The content management system may comprise a digital rights management (DRM) module, wherein the computer-implemented synchronized storytelling platform ensures that copyrighted content is protected and managed correctly.

The content management module may comprise a synchronization module 141. In one example, the synchronization module 141 may use time-coded markers to synchronize the narration with text of the digital book. The digital book may also comprise animations, in addition to any graphical display of recorded narrations accompanying the text. In various aspects, highlighted text appears in real-time as the narrator narrates. The synchronized narration with highlighted text 103 enhances the reader's engagement and makes it easier for younger readers to follow along with the story of the digital book. The synchronization module 141 ensures a seamless integration of audio, visual, and textural elements, providing an immersive reading experience.

The computer-implemented synchronized storytelling platform 100 may comprise modules for content sharing and exporting. The computer-implemented synchronized storytelling platform 100 may allow narrators to share their recorded books within the app's ecosystem in one example. The content sharing module may comprise functions to enable export of the recorded books to external programs in various file formats. The content sharing module supports both private sharing with friends and family and public sharing through broader distribution options.

The computer-implemented synchronized storytelling platform 100 may be implemented on a person computing device with a screen 101, such as a smartphone, tablet, laptop, desktop, or video casting device connected to a display module. The computer-implemented synchronized storytelling platform 100 may display a digital book, which is stored in a database 131 locally or on a network connected server. The digital book is displayed through a user interface 101 on a scheduled or organized program. In various aspects, the program is incorporated through the computer-implemented synchronized storytelling platform. In various other aspects, the computer-implemented synchronized storytelling platform is connected to existing book display programs as an add-on, wherein features may be displayed through the existing user interface.

The book display 101 may comprise video of speaker/narrator, which may be displayed as video overlay 102 on the user interface. The video of the speaker may be displayed as a small circle overlay 102. It is envisioned that the video of narrator may be modified, customized, resized, repositioned, and otherwise maneuvered to accommodate the user's preference.

The book display 101 may comprise audio narration. The audio narration may be synchronized with the video of narrator, wherein a combined audio and video output may be provided to the user to enhance the reading experience. In various aspects, the user may select their preferred narrator for the book, which may comprise a selection of the audio, the video, and/or both.

In various aspects, text of the digital book 103 may be highlighted as it is read. The highlighting of the text may be synchronized with the audio narration and video of speaker, wherein the user may be able to follow along.

The computer-implemented synchronized storytelling platform 100 may comprise control modules to enable comprehensive control over playback of the narration features. In various aspects, the control modules may enable user to play, pause, rewind, or fast forward with buttons on the user interface. The computer-implemented synchronized storytelling platform may incorporate playback sliders with word preview. The computer-implemented synchronized storytelling platform may enable user to select any word on a page of the digital book, wherein the narration audio and video jumps to that point. In various aspects, the control modules may be implemented on a touchscreen capable device, wherein users may control the playback of the narration with their hands.

The computer-implemented synchronized storytelling platform 100 may comprise playback modifier, wherein playback speed may be adjusted. The synchronization module may ensure that the playback of both the audio narration and video of speaker correspond to the playback modifier simultaneously. In various aspects, graphical representation of the playback modifier may be represented with pictures, such as bike, car, plane, to inspire interest and attention in the reader.

The computer-implemented synchronized storytelling platform 100 may comprise a synchronization module that turns the pages 103 of a digital book as the audio progresses. In various aspects, the computer-implemented synchronized storytelling platform 100 may comprise options to turn the page 103 manually or automatically. In either implementation, the audio narration and the video of speaker 102 may be played back at their respective time stamp upon turning of the page. In accordance with the subject specification, the playback speed adjustment may be applied to the turning of the book pages. In various aspects, positioning of the video 102 of speaker, whether as a bubble or small circle overlay, may be modified upon turning of the page. The positioning of the video of speaker may remain in the same or substantially same position on the display. In various other aspects, the position of the video of speaker may change according to configuration of texts, images, and other material on the following digital page. The user may set a preference on the control to designate the desired option for the page turning process.

The computer-implemented synchronized storytelling platform 100 may be used to read children's books aloud to the young readers. The computer-implemented synchronized storytelling platform may incorporate local databases to enable downloading of the digital books, along with the audio and video narration, wherein the reading experience may be provided both online and offline.

The computer-implemented synchronized storytelling platform 100 comprises a book library 131. The book library 131 may be stored on a database that is local to the user device or on a network connected server. The book library 131 may comprise databases dedicated to narrator information, audio/video record of a book, and the book content.

The database 131 storing the narrator information may comprises information for default narrators and custom created narrators. The default narrators may be provided by the app, through which the computer-implemented synchronized storytelling platform may be implemented. The default narrators may comprise previously generated videos that represent a user. In an example, the default narrators may be accompanied by artificial intelligence (AI) generated voices.

The book library 131 may comprise a recording module to enable record of audio and video for a book. The recordings may be conducted with audio processing modules, which may comprise noise cancellation. The recordings may be carried through a combined audio and video prompt by the computer-implemented synchronized storytelling platform. A teleprompter may be presented on screen through the computer-implemented synchronized storytelling platform to assist the recording of the narration. In various implementations of the computer-implemented synchronized storytelling platform on devices comprising large video displays, the user interface may provide a split screen of video recording preview and the book content.

The book narration may be previewed through the book library's recording module. In various aspects, the audio and video recording may be done separately or simultaneously. The audio and video recording may be edited and combined after individual recording. The book narration recording may be previewed on a page basis, wherein separate recordings may be conducted independently and combined upon completion of recording. In various aspects, the narrator recording may be conducted with multiple narrators, wherein the audio, video, and combination may be selected and generated according to user needs.

In an example, the book library may comprise a book database. The book database may comprise contents, such as digital pages, of the book. Additionally, the book entry may be associated with author, name, and narration time. The narration time may comprise duration categories.

A voice cloning module may be provided with the computer-implemented synchronized storytelling platform. The voice cloning module may be utilized to complement the narration recording. The voice recording may be implemented with AI voice cloning functions. In various aspects, multiple voice clones may be generated and stored within the voice cloning aspect. Language models may be implemented to record audio for books, which may be generated as interpretation of stored voice baselines based on existing recordings.

The computer-implemented synchronized storytelling platform 100 enables real-time speech-to-text highlighting. The text file 103 of the text book from the library 131 may be processed through real-time digital text snapshot, in the example of a text file 103 being a digital text page. The digital text page of the text file 103 may be captured using a view shot module at a 1-second interval or upon page change. A text recognition module may be implemented to extract text elements from the text display 103 with precise coordinate frames for each recognized word or phrase. These extracted text elements would be stored as text extraction results as optically recognized character elements.

Using a fuzzy matching algorithm, such as one utilizing Levenshtein distance, the text extraction results are processed. The text extraction results are compared with the transcript from the text files in the library 131. In an example, the first 3 words from the text extraction results and the transcript may be compared, and up to 1 character difference may be allowed for matching. Once aligned, the remaining text extraction elements may be mapped to the transcript.

For real-time synchronization, the text extraction elements are played back corresponding to the pacing of the narration recording. During playback, the computer-implemented synchronized storytelling platform may monitor audio and video position every 50 ms in an example, and highlight the corresponding text extraction element when its timestamp matches the current playback time.

Because the text extraction elements are generated dynamically and synchronized with speech in real-time, the computer-implemented synchronized storytelling platform does not rely on pre-defined text positions of any text files. As such, text files for the narration do not need to be preloaded with timestamped highlights. Rather, the synchronization module 141 coordinates the text extraction discovery with the narration video/audio output 102, wherein the text display 103 may comprise highlight overlay positioned using text element coordinates derived from either optical recognition or digital layout data.

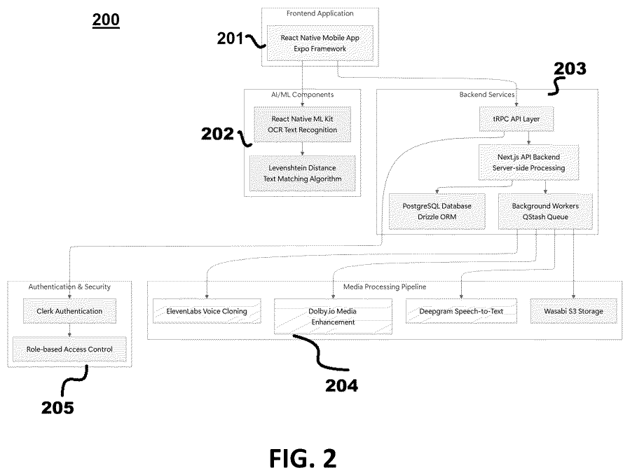

Referring to FIG. 2, a system architecture diagram 200 is provided. The computer-implemented synchronized storytelling platform may be implemented with a frontend application, a number of artificial intelligence (AI) and/or machine learning (ML) components, backend services, media processing pipeline, and an authentication and security module. The modules displayed in the figure are employed for this example of the system architecture, but the computer-implemented synchronized storytelling platform may be implemented with any specific components appropriate for each module.

In this example, the frontend application may be implemented with the React Native mobile expo framework. The AI/ML components may be implemented with React Native ML Kit and Text identification, whether optically or through native text mapping,. The AI/ML components may further be supplemented with Levenshtein distance text matching algorithm.

In this example, the backend services may comprise tRPC API layer, which may further support the authentication and security module. The authentication and security module may comprise clerk authentication and role-based access control.

The backend services may further comprise a server side processing through Next.js API backend, which may be connected to an SQL database and a workflow management queue. The workflow management queue may be connected to the media processing pipeline, which comprises a plurality of editing tools. This may include voice cloning, media enhancement, and speech-to-text modules. Further, the workflow queue may be connected to a storage service.

Referring to both FIGS. 1-2, the computer-implemented synchronized storytelling platform may implement the narration overplay 102 through the frontend application. The frontend application may be configured to operate on any third party programs that display texts, such as digital text viewers or Kindle-type readers. The frontend application may be adapted to incorporate third party text files into its own proprietary display 101.

The backend services may support the synchronization and control of the input recording 123 and library database 131. The API backend may further be configured to coordinate input recording 123 management through the media processing pipeline, such that voice cloning, media enhancement, and speech-to-text display may be conducted to support synchronization module 141 performance.

Additionally, authentication and security may be processed in relation to the input recording 123 and display overlay 102, such that role-based access control may be applied to the computer-implemented synchronized storytelling platform.

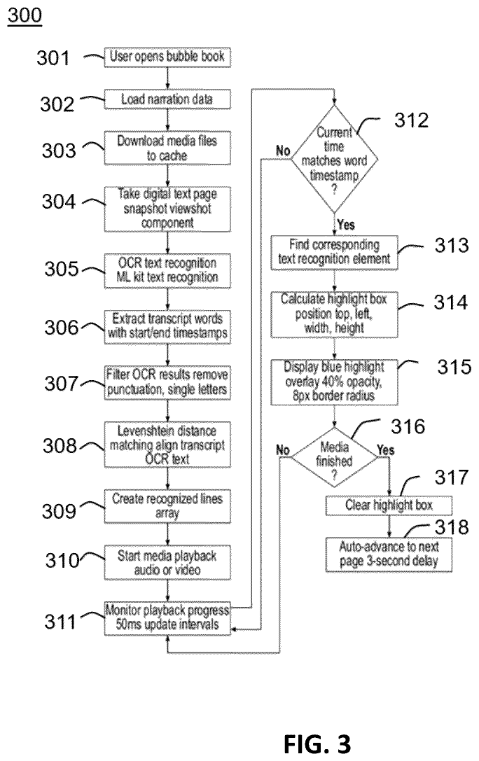

Referring to FIG. 3, a process of using the computer-implemented synchronized storytelling platform to enable speech-to-text highlighting is provided 300. A user may initiate the process by opening a user facing application 301 (named “Bubble Book” in this example) and load narration data 302. The narration data may be video and/or audio data recorded by the user on the computer-implemented synchronized storytelling platform as provided in FIGS. 1-2. Media files for the associated narration data may be downloaded to a cache 303.

The user may select a book from a library databased, wherein the book may be stored as a digital text file in an example. The digital text pages may be extracted through a digital text page snapshot function 304, wherein the texts may be processed through the optical character recognition (OCR) kit 305. OCR may be an option for the text extraction modules described herein, but is the only method intended. The OCR kit may utilize machine learning methodologies to further filter results and remove punctuations 306. The texts of the digital text pages may be extracted with start and end timestamps. In various examples, the computer-implemented synchronized storytelling platform may utilize Levenshtein distance matching methodologies to align transcript of the narration data with OCR texts 308.

The computer-implemented synchronized storytelling platform may be configured to match narration time with word timestamps 312. The computer-implemented synchronized storytelling platform may the create recognized lines arrays 309 on the extracted texts, wherein the playback of the narration data 310 may be associated with highlighting of texts on the digital text files based on the word timestamps 312. The computer-implemented synchronized storytelling platform may find the correspond text extraction element and calculate highlight box positions on the digital text page, including position, orientation, and dimension 314. The highlight may be displayed as a box overlay on top of the digital text page. The display may be provided with 40% opacity but may be adjusted based on user preference 315.

The computer-implemented synchronized storytelling platform fuses on-screen text recognition with audio understanding to deliver word-precise, time-synced highlighting in digital texts. It continuously captures what the user sees, extracts positioned text, aligns that text to word-level audio timestamps, and highlights the correct words in real time during playback.

The computer-implemented synchronized storytelling platform is configured to capture the visible digital text page using react-native-view-shot at one-second intervals and immediately on page changes, zoom, or scroll events. Captures are taken at sufficient resolution to preserve small text and are normalized to a consistent page coordinate space so that each subsequent step can rely on stable (x, y, width, height) geometry.

Each snapshot may be processed by an on-device text recognition pipeline that outputs text tokens with precise bounding boxes. For every recognized word or short phrase, we store its normalized text and geometry in page coordinates. Tokens are ordered in natural reading order and grouped by line and block to maintain semantic structure while preserving per-token coordinates for fine-grained highlighting.

In an example, the computer-implemented synchronized storytelling platform aligns text extraction tokens to Deepgram's word-level transcript using a fuzzy matching strategy based on Levenshtein distance. This may be accomplished by comparing the first three text extraction tokens to the first three transcript words, tolerating up to one character of edit distance per word to absorb minor text extraction errors. Once an anchor is found, both sequences may be advanced, mapping each text extraction token to its corresponding transcript word and inheriting its start/end timestamps.

During playback, the computer-implemented synchronized storytelling platform may be configured to sample the current media position approximately every 50 ms 311 and select the active token by searching for the timestamp interval that contains the current time 312. The corresponding text extraction element's bounding box is highlighted directly over the digital text view. Highlight transitions are smoothed to reduce flicker, and the system gracefully suspends or re-anchors highlighting on page changes or seeks, ensuring that visual focus stays synchronized with the audio at word-level precision.

The text-to-speech function may further be supplemented by a voice cloning process, wherein voice models of a narration may be processed as character timestamps. The character timestamps may be generated by analyzing the narration recording to determine the pronunciation, cadence, and word recognition of the voice model. Concurrently, the digital text file may be analyzed to generate word-level timestamps. Finally, the character timestamps may be converted to match the word-level timestamps, such that the voice cloning of the narration may match highlighting of the texts on the digital text file.

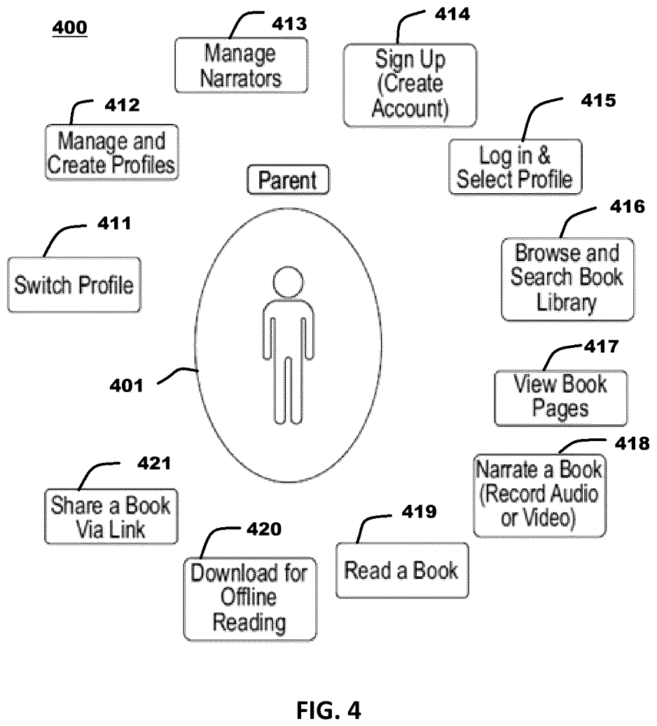

Referring to FIG. 4, an overview of the computer-implemented synchronized storytelling platform in accordance with the subject disclosure is shown 400. In an example, the computer-implemented synchronized storytelling platform may be accessed by a user 401, who may be a parent. The computer-implemented synchronized storytelling platform may be accessed through a personal computing device by the parent to complete a plurality of tasks. The parent may access the platform to conduct create, manage, and switch profiles 411-412. The profiles may be user profiles that associate with a number of features and preferences that the parent may have, or alternatively the parent would select for the prospective readers. The profiles may be created or accessed through account creation portals, which may be implemented to regulate profile log in and selection. The platform may provide a dashboard that leads to a book library 416, which may be linked to a narrator library. Alternatively the narrator library may be managed separately from the book library, wherein the book and narrator library may be linked according to user preference and selection.

The book library accessible through the parent dashboard may enable the user to browse and search through contents stored within. The books stored may be tagged, sorted, organized, or characterized by a plurality of attributes, which may comprise read status, date/time of reading, time setting, narration status, and achievement/badge status. In various aspects, the book pages may be viewed sequentially or individually, which may be associated with narrator data from the narrator library 413. The book library may enable a user to read a book, download a book for offline access, or share a book. The sharing of the book may be achieved through any of the standard file sharing methodologies, which may comprise wireless, Bluetooth, or web links. In various aspects, the computer-implemented synchronized storytelling platform may be implemented with cloud computing networks, wherein remote servers may be accessed to accommodate storage and utilization of the book and narrator libraries.

The computer-implemented synchronized storytelling platform may comprise a narration recording function 418, wherein the user may record a narration of any story or book in both audio and video format. The narration recording function may be accessed or provided through the user dashboard. The recorded narration may be stored within the narrator library, wherein contents and aspect of the narration may be further organized, sorted, and associated with the digital books in the book library. In various aspects, the narration may be further associated with individual pages of the digital books in the book library.

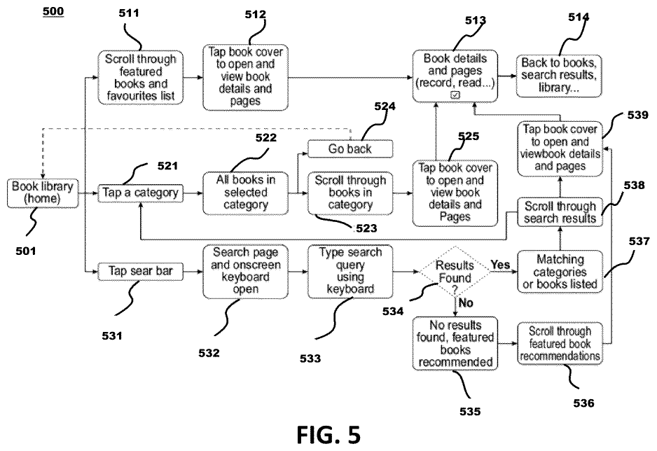

Referring to FIG. 5, an example of a book library on the computer-implemented synchronized storytelling platform is shown 500. The computer-implemented synchronized storytelling platform 500 may enable access to digital books on within the book library through a number of options, some of which are illustrated in the example. The user may scroll through featured books and favorite lists 511, wherein books may be tagged with identification attributes in order to be presented according to user preference. In various aspects, the user preference may be identified through machine learning methodologies implemented through the computer-implemented synchronized storytelling platform. Each book presented in the featured or favorite list may be accessed through touchscreen on a mobile phone or tablet, for example. The book details may be revealed upon selection of the book, including biblical information, associated narrations, and digital text and image contents 512-514.

In an example, the book library may enable users to browse through stored books organized via categories 521. The user may browse through books in each selected category and access selected books through direct access.

In an example, the book library may enable users to browse through stored books via a search bar 531, which may allow a user to search page, keywords, phrases and other identifiers. In an example, the search bar may be provided in association with an onscreen keyboard. It is envisioned that machine learning methodologies, including language learning models, may be incorporated in to the search function to enhance search results.

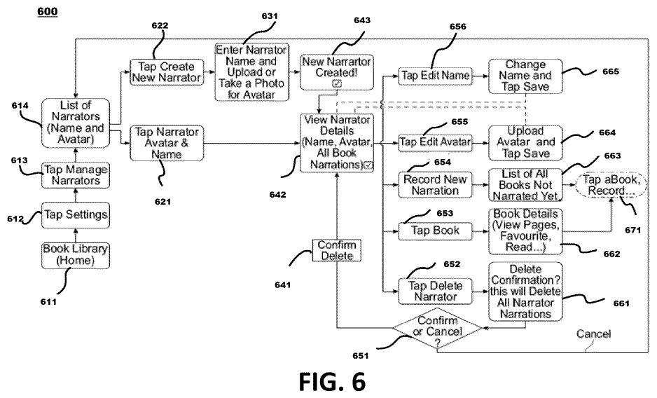

Referring to FIG. 6a-c, a process of utilizing the digital book library on the computer-implemented synchronized storytelling platform is shown. In an example, the book library may be a home screen on an app installed on a digital device. The book library home page may comprise a “settings” button, which may allow a user to access through tapping on a touchscreen, for example. In various other aspects, any of the function buttons on the computer-implemented synchronized storytelling platform may be accessed through any known input methodology associated with electronic and computing devices at any time.

The book library home screen may comprise a portal to allow users to manage narrators, which may be presented to the user as a list of narrators. The narrators may be presented to the user via at least one name and an avatar. The narrator's portal may allow a user to view existing narrators and create new ones.

For creation of new narrators, the computer-implemented synchronized storytelling platform may allow a user to enter a name and upload a photo to begin the process. In various aspects, the computer-implemented synchronized storytelling platform may incorporate camera components on a user device to enable taking a photo of a user in order to create an avatar. The computer-implemented synchronized storytelling platform may incorporate generative AI modalities to provide avatar generation functions. The newly created narrators are stored in the database that the book library connects to.

With both existing and newly created avatars, the book library homepage may allow users to access through their respective icons, wherein narrator detail information can be viewed. The narrator detail information may comprise name, avatar visual, and narrations. In various aspects, at least one narration may be associated with each narrator. It is envisioned that the narration and narrator selection may be preset, randomly arranged, or specifically arranged by the user. The computer-implemented synchronized storytelling platform provides access between database for the narration and the narrator avatars, wherein individual pairings may be facilitated between two data sources.

In the exemplary illustration, the computer-implemented synchronized storytelling platform may allow a user to edit name, edit avatar, record narration, view book details, and delete narrator. The narrator name may be changed and saved in the same database location. The associated avatar may be changed by uploading a new image file, wherein the storytelling platform may incorporate into animated format through graphical processing methodologies.

The computer-implemented synchronized storytelling platform may provide a list of books without saved narration, wherein the user may utilize the functions provided by the platform to record narration accordingly. In various aspects, the narration recording may be coordinated with video recording, wherein the avatar may be overlaid or replaced by the video recording. The narration files may be associated with each book, wherein the audio, video, or both recording files may be saved in designated memory locations within the book library database. The book details may be viewed before, during, or after recording the narration, wherein individual pages may be associated with specific narration recordings. The computer-implemented synchronized storytelling platform provides functions to enable favorite designations.

The computer-implemented synchronized storytelling platform may provide editing capabilities to saved narrations, including sorting, tagging, or deleting the narrations. A user may be provided functions to collectively edit groups of narrations associated with certain tags, such that narration associated with certain users, books, or timeline may be changed, updated, or deleted.

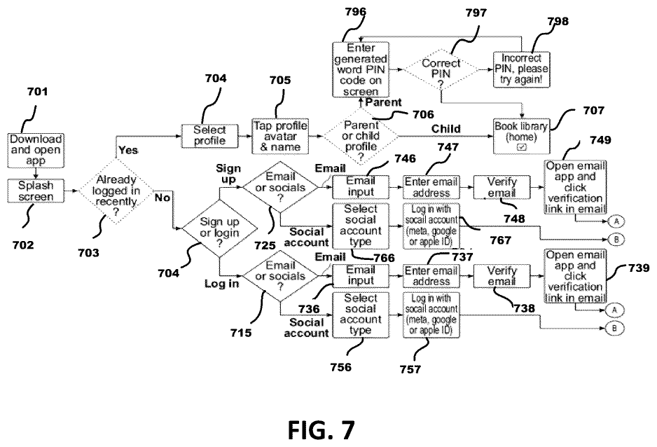

Referring to FIG. 7, an example process of a mobile app implementation of the computer-implemented synchronized storytelling platform is provided 700. The digital storytelling mobile app may be downloaded from any of the app stores accessible by the user's digital device. The user's access may be regulated by individual profiles. At a splash screen of the mobile app, the user profile may be checked to identify whether recent log ins have occurred. The mobile app stores information of profiles, wherein regular users may access the mobile app with minimal log in process if it is identified as a recent log in. The profile may be selected by the user, wherein either a parent or child access, for example, may be enabled depending on user permissions. In various aspects, security measures may be provided to ensure only authorized users may access the designated content within the book library. In various aspects, the user may create a new profile through a sign up process, if a profile has not been previously created and/or associated with the user. The computer-implemented synchronized storytelling platform may be configured to enable access through profiles via email or social media profiles. In various aspects, multi-factor authentication methods may be utilized to enhance access verification.

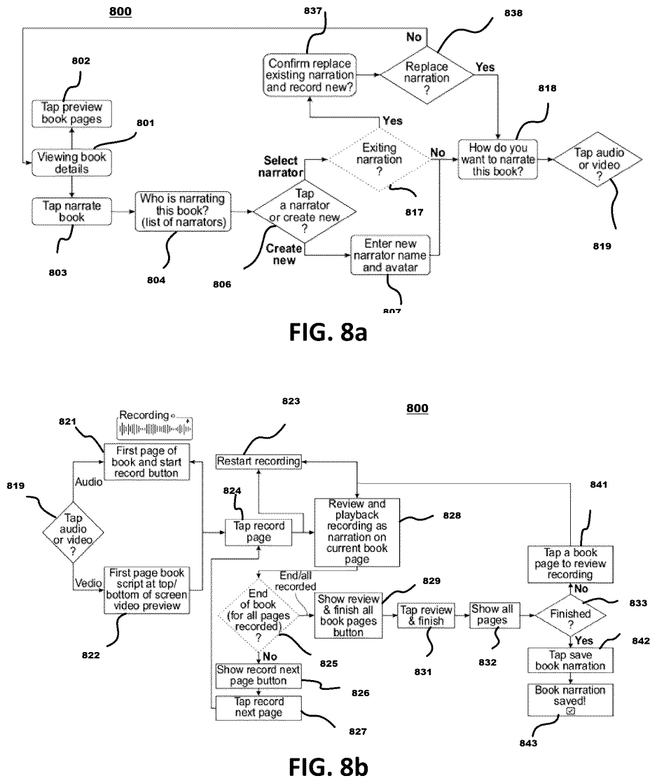

Referring to FIG. 8a, an example of a process to narrate a book utilizing the computer-implemented synchronized storytelling platform is provided. To begin the process, a user may select a book to view the book pages and details. Should the user choose to add narration to the book, the user may interact with a function signifying the narration process. The user may select a narrator from a list of narrators, which may be stored in a narrator database. If a narrator exists, the associated narration may be replaced by recording over the existing data file. A security process may be carried to ensure that the existing narration can be replaced. If the user prefers to record a new narration using a new narrator, the user may enter a new narrator's name and select an avatar image. The avatar image may be created by adding a photo previously taken and stored on the digital device. Alternatively, the avatar image may be created in the instance by taking a selfie with a camera. With both the existing narrator or new narrator, the user may be prompted to record the narration in audio, video, or combined modes.

Referring to FIG. 8b, an example of a process to narrate a book utilizing the computer-implemented synchronized storytelling platform continues. If a user selects audio narration, the computer-implemented synchronized storytelling platform may incorporate functions of audio recording from other apps. In various aspects, the computer-implemented synchronized storytelling platform may be configured to interact with third party recording programs, wherein visual recording cues may be provided alongside to assist with recordation. The user may interact with each page of the digital book selected from the story library to begin. If a user selects visual narration, the computer-implemented synchronized storytelling platform may be configured to provide a split screen layout, enabling higher contrast for texts displayed in synchronized manner with the audio.

With both recording modes, the user may access the recording functionality through a record page to begin. As the book narration is recorded, an internal algorithm is carried to ensure that the synchronization process is implemented. This ensures that the cadence, pace, and tone of the user's audio recording is synchronized with the display of the texts. In various aspects, the narration may be synchronized with reading cadence of the reader.

In an example, the computer-implemented synchronized storytelling platform comprises an intelligent teleprompter system. Similar to the manner in which the highlight overlays are generated in real-time due to Text identification, whether optically or through native text mapping,, the narration may be assisted with real time context-aware text display during recording. The text extraction methodologies described in the preceding figures may be utilized to recognize texts in a storybook, such that the texts on the teleprompter may be generated in real time based the pacing of the narration. In various implementations, the synchronization module 141 in FIG. 1 may be utilized to coordinate display of teleprompter texts to correspond to the narrator's pacing.

The intelligent teleprompter system may comprise context-aware text display that shows page-specific content during recording with automatic scrolling and formatting. The intelligent teleprompter system enables real-time speech-to-text highlighting during the narration recoding process. As in FIG. 1, the text file 103 of the text book from the library 131 may be processed through real-time digital text snapshot, in the example of a text file 103 being a digital text page. The digital text page of the text file 103 may be captured using a view shot module at a 1-second interval or upon page change. A text recognition module may be implemented to extract text elements from the text display 103 with precise coordinate frames for each recognized word or phrase. These extracted text elements would be stored as text extraction results as optically recognized character elements. The text extraction results may then be displayed to the narrator on the intelligent teleprompter.

Because the text extraction elements are generated dynamically and synchronized with speech in real-time, the computer-implemented synchronized storytelling platform does not rely on pre-defined text positions of any text files. The narrator may read the texts from the intelligent teleprompter as they would normally, and the text extraction elements would be presented to them based on their demonstrated pacing. In a sense, this may be viewed as the reverse synchronization process provided during the narration playback process.

Upon completion of recording, the computer-implemented synchronized storytelling platform may provide a review process, wherein the digital story book associated with the synchronized recording may be reviewed. Each page of the digital book may have individual narration files associated, such that individual page reviews may be facilitated. Upon confirmation and approval of the recording quality, the user may indicate through a save book narration button that the narration may be saved along with the digital book within the book and narration library.

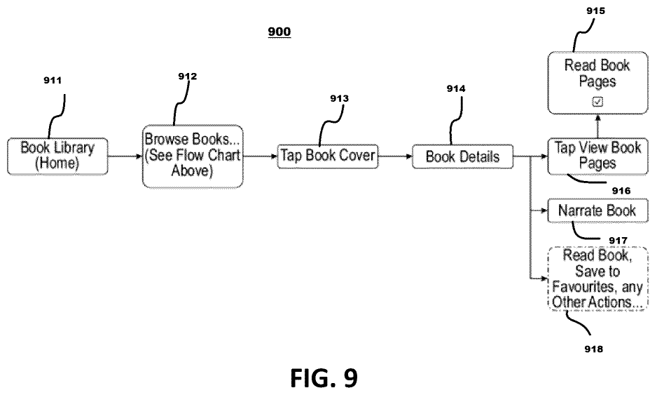

Referring to FIG. 9, a page viewing process from a parent user's perspective is shown. The parent user may browse the book library for books, wherein the book details may be presented. The parent may choose to view book pages, view book narration, or narrate a book. The parent user may be provided editing privileges to assign favorited or featured tags to the digital books, wherein certain books may be presented to the child users through parental supervision.

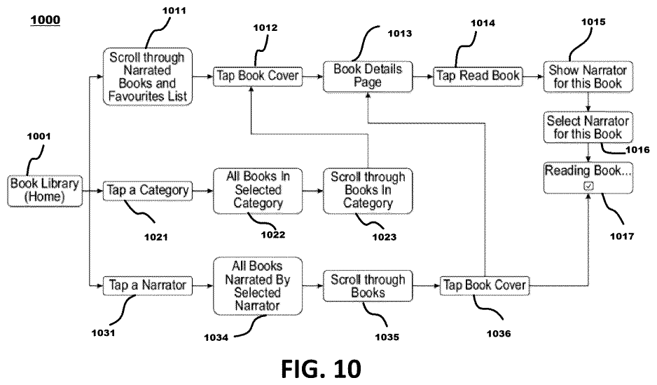

Referring to FIG. 10, a page viewing process form a child user's perspective is shown. A child user may browse through books organized through a featured list, favorite list, category, and narrator. Each of the digital books may be assigned specific attributes to enable robust search and sorting capabilities for child users.

When a child user selects a book to read, an associated narration may be shown to the child user. It is foreseeable that multiple narrations may be associated with each digital book, wherein multiple family members or friends may have their individual recording for a digital book. It is envisioned that narration recordings may be provided by other users to any book in a library, such that users may experience book reading from a number of different narrators. This further provides users with the ability to fully appreciate the variations of narration style, cadence, and care.

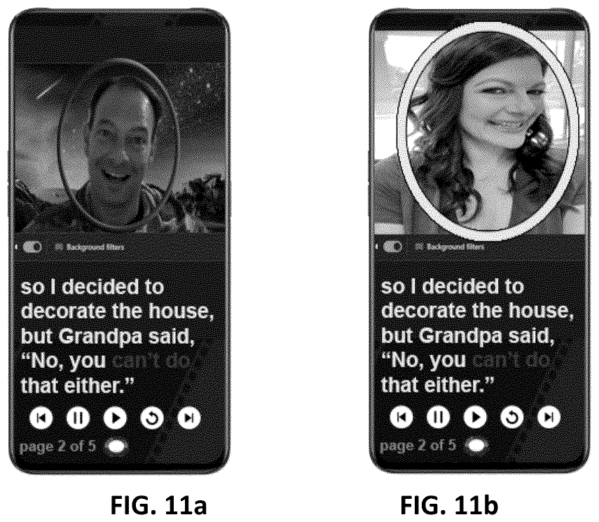

Referring to FIG. 11, an example of a narration recording screen on the computer-implemented synchronized storytelling platform is shown. The computer-implemented synchronized storytelling platform may comprise a user interface that provides text display to assist a user's narration. In the example, the user has uploaded a picture of their face. The user interface may comprise photo editing functions to enable the user to crop the desired portion of the uploaded photo to use as display. Simultaneously, the computer-implemented synchronized storytelling platform may comprise a teleprompter display along with the photo, wherein texts are highlighted to provide direction during recordation of narration. In various aspects, the user may set preferred narration pacing in preparation for recording, wherein the highlighting of the texts may be generated accordingly.

In various aspects, the computer-implemented synchronized storytelling platform may incorporate artificial intelligence methodologies, including language models, in order to determine the appropriate pacing of narration live during recording. The user interface may utilize the pacing determined by the language model methodology to generate highlighted texts accordingly.

Referring to FIG. 11b, another picture or video can be uploaded to the computer-implemented synchronized storytelling platform to be associated with the recording. The narration recorded may be synchronized with videos of various narrators according to pacing of the respective recording. In an example of still images being associated with each narration recording, the user may select any that would optimally represent the image that captures the reader's attention. The reader may select any of the narrator combination of audio recording and picture/video recording to supplement their preferred reading experience.

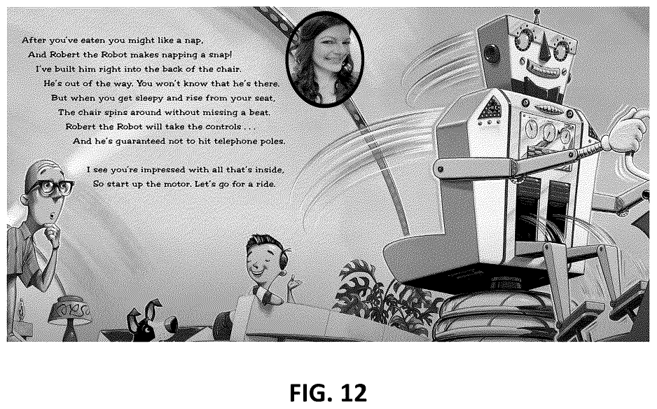

Referring to FIG. 12, an example of a digital book implemented on the computer-implemented synchronized storytelling platform is shown. The digital story page is displayed on a screen of a digital device that a reader user utilizes to access the computer-implemented synchronized storytelling platform. The narration may begin upon changing of the digital page from the preceding one, in an example. In various aspects, the narration may be initiated only by interacting with a begin button on the digital page. In the example, an image or video from the narration recording in FIG. 11b is displayed on the story page. The computer-implemented synchronized storytelling platform utilizes computer vision to select a display area that is the least disruptive to the story reading experience. As shown in the example, the narrator display is overlaid on an area of the digital page that does not contain texts or significant imageries. A proprietary software algorithm may be utilized to ensure that the narrator display is modified and resized to fit on the appropriate section of the digital page. In various aspects, the narrator display area may be animated to change display location through the narration process, providing increased attention capturing potentials.

In the example, the narration display may be synchronized with display of highlighted texts on the digital page in accordance with pacing of the audio component of the narration. The computer-implemented synchronized storytelling platform may be implemented to provide a seamless narration experience for the reader, wherein the highlighting of digital texts may be generated in real time.

The text of the book may be imported as a digital text page from a book in the library database, wherein the texts have been digested to created word level time stamps. The playback of the display overlay may be configured to correspond to the word-level timestamps of the digital text page. As the narration progresses, highlight boxes may be implemented on the digital text page to correspond to the playback of the display overlay. As such, the reader may experience a book being read to them by the narrator, wherein texts highlights are generated at the same pace as the narration.

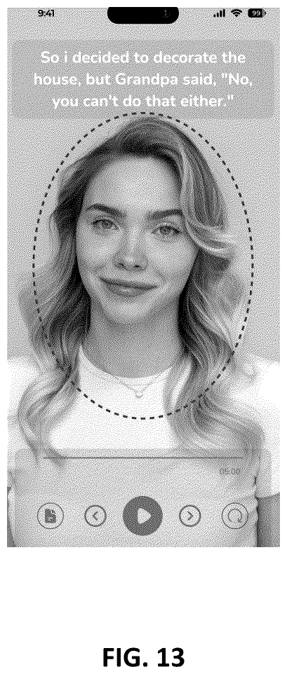

Referring to FIG. 13, an example of a digital page of narration recording utilizing the computer-implemented synchronized storytelling platform in accordance with subject disclosure is provided.

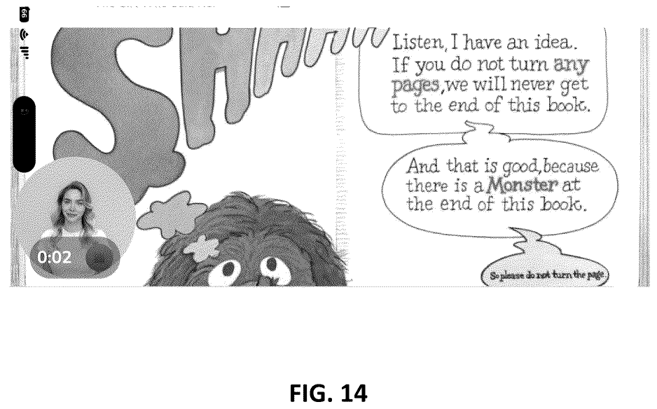

Referring to FIG. 14, an example of a digital page of narration recording utilizing the computer-implemented synchronized storytelling platform in accordance with subject disclosure is provided.

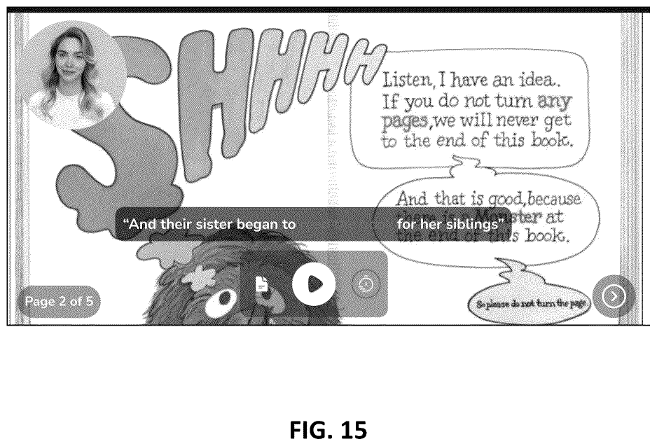

Referring to FIG. 15, an example of a digital page playing back a recorded narration utilizing the computer-implemented synchronized storytelling platform in accordance with subject disclosure is provided. In this example, the display overlay may display the narrator's profile icon. Alternatively, the display overlay may display playback of the narrator's video recording. The text of the book may be imported as a digital text page from a book in the library database, wherein the texts have been digested to created word level time stamps. The playback of the display overlay may be configured to correspond to the word-level timestamps of the digital text page. As the narration progresses, highlight boxes may be implemented on the digital text page to correspond to the playback of the display overlay. As such, the reader may experience a book being read to them by the narrator, wherein texts highlights are generated at the same pace as the narration.

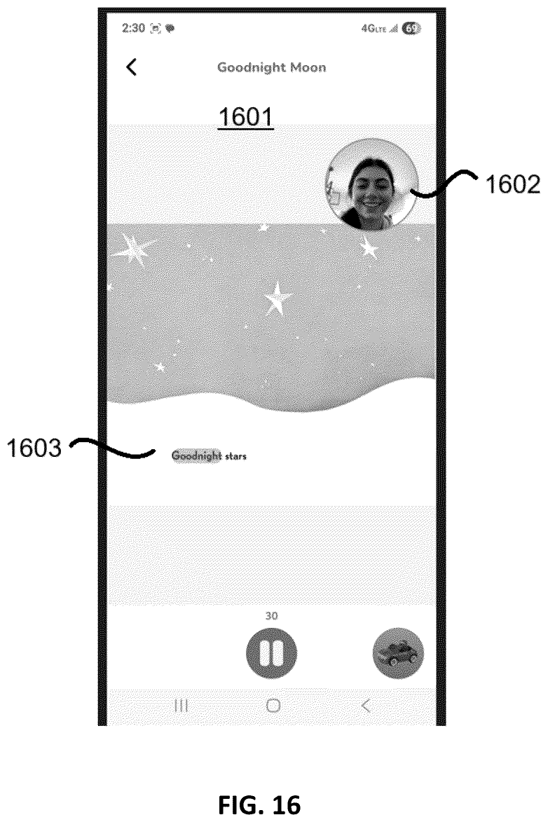

Referring to FIG. 16, an example of a digital page playing back a recorded narration utilizing the computer-implemented synchronized storytelling platform in accordance with subject disclosure is provided. In this example, a highlight overlay 1603 is generated over the text, which correspond to when the narrator 1602 speaks that word. As described in accordance with FIGS. 1-3, the highlight overlay 1603 is generated in real-time based on text extraction, such that the texts is recognized at the pacing of the narration 1602. The highlight overlay 1603 is not pre-generated and embedded onto the text file, as would be in conventional digital books.

The features described therein may be implemented on digital book files that is specifically created for the computer-implemented synchronized storytelling platform, wherein a dedicated file format or name may be provided. In various aspects, the computer-implemented synchronized storytelling platform may be implemented as an add-on feature to existing digital book apps. In various aspects, the computer-implemented synchronized storytelling platform may be integrated with third part digital reading platforms, wherein third-party file formats may be converted and displayed on the computer-implemented synchronized storytelling platform. In an example, an app implementing the computer-implemented synchronized storytelling platform may accept third party digital book files acquired from online vendors and generate a narrator display along with an audio recording, wherein the third digital book files may not contain native audio or video components. In various aspects, the computer-implemented synchronized storytelling platform may comprise a dynamic database, wherein external files may be input through a processor to act as basis for a narration supplemented display. In an example, the digital page displayed in FIG. 12 may be from a third party app, which is not natively constructed for the computer-implemented synchronized storytelling platform. In the example, the narrator display and narration is generated over the existing data file and provided to the user.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is

1. A computer-implemented synchronized storytelling platform comprising:
a recording module configured to obtain narration input data,
a database configured to store at least one book file, wherein the book file comprises a plurality of book pages, each of the plurality of book pages comprises text instances,
a synchronization module configured to assign timestamps to the narration input data and map the timestamps to the text instances, and
a display module
wherein
the display module generates a display of the book file, displaying each of the plurality of book pages,
the display module generates an output overlay over a display of the book file, wherein the output overplay comprises an output display of the narration input data at an output cadence based on the timestamps, and
the display module generates a highlight overlay over the text instances according to the output cadence.

2. The computer-implemented synchronized storytelling platform of claim 1, wherein the narration input data comprises audio and video data.

3. The computer-implemented synchronized storytelling platform of claim 1, wherein the synchronization module comprises at least one machine learning component configured to process optical character recognition on the text instance.

4. The computer-implemented synchronized storytelling platform of claim 2, wherein the at least one machine learning component is configured to perform fuzzy string matching.

5. The computer-implemented synchronized storytelling platform of claim 1, comprising a backend service module connected to the recording module and the synchronization module, wherein the backend service is configured to process speech-to-text based on the narration input data and the text instances.

6. The computer-implemented synchronized storytelling platform of claim 1, wherein the recording module comprises a teleprompter module configured to automatically generate a transcript on the text instances.

7. The computer-implemented synchronize storytelling platform of claim 6, wherein the teleprompter module is configured to display the transcript based on the timestamps.

8. A computer-implemented method for synchronized storytelling platform comprising:
obtaining narration input data from a recording module,
loading at least one book file from a database, wherein the book file comprises a plurality of book pages, each of the plurality of book pages comprises text instances,
assigning timestamps to the narration input data,
mapping the timestamps to the text instances,
displaying the book file on a display module,
recognizing, optically, the text instances of the book file,
generating an output overlay of the narration input data over the book file, and
generating a highlight overlay over each of the text instances according to an output cadence based on the timestamps.

9. The computer-implemented synchronized storytelling platform of claim 8, wherein the narration input data comprises audio and video data.

10. The computer-implemented synchronized storytelling platform of claim 8, comprising using at least one machine learning component configured to recognize, optically, the text instances.

11. The computer-implemented synchronized storytelling platform of claim 9, wherein the at least one machine learning component is configured to perform fuzzy string matching.

12. The computer-implemented synchronized storytelling platform of claim 8, comprising processing speech-to-text based on the narration input data and the text instances according to the output cadence.

13. The computer-implemented synchronized storytelling platform of claim 8, comprising generating a transcript on the text instances while obtain the narration data.

14. The computer-implemented synchronize storytelling platform of claim 13, comprising displaying the transcript based on the timestamps.

15. A computer-implemented synchronized storytelling platform comprising:
an input module for obtaining narration data,
a database for storing at least one book file, wherein the book file comprises a plurality of book pages, each of the plurality of book pages comprises text instances,
a processing module configured to optically recognize the text instances, and
a display module for displaying the narration data at an output pace and generating a highlight overlay on the text instances according to the output pace.

16. The computer-implemented synchronized storytelling platform of claim 15, wherein the narration input data comprises audio and video data.

17. The computer-implemented synchronized storytelling platform of claim 15, wherein the synchronization module comprises at least one machine learning component configured to process optical character recognition on the text instance.

18. The computer-implemented synchronized storytelling platform of claim 16, wherein the at least one machine learning component is configured to perform fuzzy string matching.

19. The computer-implemented synchronized storytelling platform of claim 16, wherein the recording module comprises a teleprompter module configured to automatically generate a transcript on the text instances.

20. The computer-implemented synchronize storytelling platform of claim 19, wherein the teleprompter module is configured to display the transcript based on the timestamps.
